(19) United States
(12) Patent Application Publication
(10) Pub. No.: US 2015/0360350 A1
(43) Pub. Date: Dec. 17, 2015

(54) Multi-purpose ratchet piper pliers

(71) Applicant: Zhangmei JIANG, Fuzhou City, Fu (CN)

(72) Inventor: Zhangmei JIANG, Fuzhou City, Fu (CN)

(21) Appl. No.: 14/347,019

(22) PCT Filed: Mar. 28, 2013
(86) PCT No.: PCT/CN2013/073312

§ 371 Date: Mar. 25, 2014

(30) Foreign Application Priority Data
Mar. 7, 2013 (CN) 201310073321.X

(51) Int. Cl. B25B 13/50

(52) U.S. Cl. CPC B25B 13/5058

(57) ABSTRACT

A piece of multi-purpose ratchet pipe plier comprise a handle, an upper jaw clamp, a pin shaft, a torsion spring, an arc-shaped tooth surface insert block and an upper tooth surface inert block, wherein the upper jaw clam is hinged on the handle through the pin shaft, the torsion spring is arranged in the assembly slot of the handle and connect with upper jaw clam and the bottom of assembly slot in the ends, the arc-shaped tooth surface insert block is fixed on the handle by tenon, and the upper tooth surface insert block is fixed on the upper jaw clamp by tenon. The anti-skip teeth on the handle and the upper jaw clamp are disassembled and replaced, the whole plier opening can clamp the pipe through the tooth surfaces at three different directions for realizing anti-skip function.

### CLAIMS OF PRIORITY

This utility patent application claims priority to CN Application No. 201310073321.X filed on Mar. 7, 2013, which is incorporated herein by reference in its entirety.

### FIELD OF THE PRESENT INVENTION

The present invention relates to a piece of pipe plier, in particular to a piece of multi-purpose ratchet pipe plier.

### BACKGROUND OF THE PRESENT INVENTION

The ratchet wrench is generally used for tightening or loosening water pipes connected by various nuts, bolts and threads or other special workpieces. The invention patent, with Chinese patent publication number “CN1353032A” and title of “multi-purpose fast ratchet wrench”, discloses a wrench, which comprises a handle, a hook-shaped jaw and a spring fixing structure, wherein the head of the wrench is semi-circular, and is provided with a strip slot at the lower so as to receive the rear part of the hook-shaped jaw inserted into the slot, then the rear part of the hook-shaped jaw is fixed in the strip slot through a pin; the spring fixing structure mainly comprises a spring and a spring fixing pin; the spring fixing pin crosses through the strip slot to form a fixed supporting point on which one end foot of the spring is wound, the other end foot of the spring penetrates into the part inserted the strip hole of the hook-shaped jaw to form another supporting point, and the abdomen and back of the jaw head and the semi-circular head of the handle are provided with anti-skip teeth respectively.

However, in the use process, the ratchet wrench has many defects which are as follows:

1. the wrench camps a workpiece for realizing the anti-skip function in the way that the tooth surface with anti-skip teeth of the head of the handle is fit with the tooth surface of the hook-shaped jaw, the semi-circular part with anti-skip teeth of the head of the handle, the handle, the tooth surface of the hook-shaped jaw and the whole hook-shaped jaw form an inseparable whole, and the structure has the two defects that:

1) for users, the part with the anti-skip teeth at abdomen side of the head of the jaw, and the head of the jaw form an inseparable whole, if use for a long time, the anti-skip teeth can gradually be worn to finally lose the anti-skip function, finally, the wrench is scrapped, at this time, the most parts of the wrench are normal and usable, only the anti-skip teeth are damaged, so the defects of the structure lead to big loss because of small damage, therefore reducing the service life of the wrench and bringing great waste.

2) for producers, in the manufacturing, if the mechanical performance needs to be improved, materials with good quality are needed, however, the integrated design leads to the condition that the whole of pipe plier are only manufactured by a united material, the anti-skip teeth at the jaw need to be manufactured by materials with good quality, other parts can be made from common materials, thus, the integrated ratchet wrench is increased in cost of material selection.

2. in working, the wrench clamps the workpiece only by two tooth surfaces, if the angle of the appearance of the workpiece is the same as the angle of the wrench jaw, the wrench can realize its objective better, but, if no, it is not reliable to clamp components by the wrench, such as pipes and the like.

3. the rear reset force of the opening of the hook-shaped jaw of the wrench is realized by a torsion spring, the two arms of the torsion spring are staggered, and are not on the same plane, the spring deforms to produce tension for rotation reset of the hook-shaped jaw and simultaneously produce uncoordinated force in reset of the hook-shaped jaw, so that the hook-shaped jaw can scrape the side wall of the assembled slot in reset, and in the actual use process, the phenomenon that the hook-shaped jaw is clamped and can not reset occurred.

4. when the wrench is at the minimum opening, the rear part of the hook-shaped jaw stops at the middle of the semi-circular tooth surface of the head of the handle, so that the middle of the rear part of the semi-circular tooth surface becomes a strip slot to lose anti-skip teeth, only the anti-skip teeth are retained at the narrow semi-circular tooth surfaces at two sides of the slot, the semi-circular tooth surfaces are right the positions for clamping the workpiece with maximum diameter, the tooth surfaces of the wrench, for clamping the workpiece, must be maximum, but it is minimum now.

5. the cross section of the front part of the hook-shaped jaw of the wrench is rectangular, and in the large-size wrenches, the hook-shaped jaw seems heavy, and can not flexibly reset.

### SUMMARY OF THE PRESENT INVENTION

The present invention aims to provide a piece of multi-purpose ratchet pipe plier, which is reasonable in design, simple in structure, long in service life, low in manufacturing cost, firm in clamping, light in weight, good in strength, wide in functions and fast and reliable in working.

For solving the above technical problems, the present invention provides a piece of multi-purpose ratchet pipe plier, which comprises a handle, an upper jaw clamp, a pin shaft and a torsion spring, wherein the handle is provided with an assembly slot, the upper jaw clamp is connected on the assembly slot though the pin shaft, the torsion spring is arranged in the assembly slot, one driving end of the torsion spring is arranged on the upper jaw clamp, the other end of the torsion spring is arranged on the assembly slot, the multi-purpose ratchet pipe plier further comprise an arc-shaped tooth surface insert block and an upper tooth surface insert block, the arc-shaped tooth surface insert block comprises an arc-shaped tooth surface and a lower tenon, the head of the handle is provided with a lower mortise fit with the lower tenon, and the lower tenon and the lower mortise are matched to fix the arc-shaped tooth surface insert block on the handle;

The tooth surface insert block comprises an upper tooth surface and an upper tenon, the upper jaw clamp is provided with an upper mortise fit with the upper tenon, and the upper mortise is fit with the upper tenon to fix the upper tooth surface insert block on the upper jaw clamp.

The improvement of the present invention is in that: the lower tenon is arranged at the middle of rear end of the arc-shaped tooth surface, the lower tenon and the arc-shaped tooth surface are in stepped transition, the lower tenon is a straight tenon with rectangular cross section, the lower mortise is a straight long slot with rectangular cross section, and when the lower tenon is inserted into the lower mortise, the stepped surface of the connection position of the arc-shaped tooth surface and the lower tenon tightly presses on the top surface of the wall of the lower mortise;

The upper tenon is arranged at the middle of the rear end of the upper tooth surface, the connection position of the upper tenon and the upper tooth surface are in stepped transition, the upper tenon is a straight tenon with rectangular cross section, the upper mortise is a straight long slot with rectangular cross section, and when the upper tenon is inserted into the upper mortise, the stepped surface of the connection position of the upper tooth surface and the upper tenon tightly presses on the top surface of the wall of the upper mortise.

Specifically, the wall has sufficient thickness to meet the strength requirements.

The improvement of the present invention is in that: the multi-purpose ratchet pipe plier further comprise a first fixing device and a second fixing device, when the lower tenon is inserted into the lower mortise, the first fixing device is used for fixing them, and when the upper tenon is inserted into the upper mortise, the second fixing device is used for fixing them.

The improvement of the present invention is in that: the first fixing device is an anti-drop screw, one side wall of the lower mortise is provided with a transparent hole, the other side wall of the lower mortise is provided with a first screw hole, the lower tenon is provided with a through hole, and the anti-drop screw sequentially penetrates through the transparent hole and the through hole to be fit with the first screw hole so as to fix the lower tenon on the handle.

The improvement of the present invention is in that: the second fixing device comprises a fixing screw, one side wall of the upper mortise is provided with a fixing screw hole, and the fixing screw firmly holds the upper tenon through the fixing screw hole so as to fix the upper tenon on the upper jaw clamp.

The improvement of the present invention is in that: the upper tooth surface is a V-shaped tooth surface, and the opening end of the V-shaped tooth surface faces to the handle.

The improvement of the present invention is in that: the tooth angles of the arc-shaped tooth surface and the upper tooth surface are less than 90 degrees, and are arranged inwards obliquely.

The improvement of the present invention is in that: the multi-purpose ratchet pipe plier further comprise a first tenon-disassembly screw for pushing the lower tenon out of the lower mortise, the handle is provided with a second screw hole communicated with the lower mortise, the first tenon-disassembly screw is arranged in the second screw hole, and the tail end of the first tenon-disassembly screw is propped against the lower tenon.

The improvement of the present invention is in that: the multi-purpose ratchet pipe plier further comprise a second tenon-disassembly screw for pushing the upper tenon out of the upper mortise, the handle is provided with a third screw hole communicated with the upper mortise, the second tenon-disassembly screw is arranged in the third screw hole, and the tail end of the second tenon-disassembly screw is propped against the upper tenon.

The improvement of the present invention is in that: the multi-purpose ratchet pipe plier further comprises a limit pin, the torsion spring is a parallel-arranged double-torsion spring, the limit pin is arranged above the root of the lower arm of the parallel-arranged double-torsion spring to limit the lower arm of the spring to move only by clinging to the bottom of the assembly slot.

The end part of the upper arm of the parallel-arranged double-torsion spring is connected with the rear arm of the upper jaw clamp, the upper jaw clamp rotates to produce the change in the included angle between the upper arm and the lower arm of the parallel-arranged double-torsion spring, as a result, the produced spring tension is always used for holding the upper jaw clamp, so that an opening for the pipe plier to clamp the workpiece can be formed between the upper tooth surface insert block of the upper jaw clamp and the arc-shaped tooth surface insert block of the head of the handle.

The present invention has the beneficial effects that: in the multi-purpose ratchet pipe plier in a new structure, the anti-skip teeth on the handle and the upper jaw clamp can be disassembled and replaced, for the users, when the anti-skip teeth at the jaw are worn so as not to be used, the wrench can not be scrapped by only replacing the two insert blocks, for the producers, in material selection for improving the quality, materials with good quality are selected only for the two insert blocks, the other parts can still use common materials, the while plier opening can clamp a pipe through tooth surfaces at three different directions for realizing anti-skip function, further, the upper jaw clamp is reasonable in structure, light in weight and good in strength, the newly-adopted parallel-arranged double-torsion spring is compact and symmetric in structure, good in elasticity without uncoordinated force, and good in performance, and the whole multi-purpose ratchet pipe plier are low in cost, long in service life, wide in function and fast and reliable in working.

### BRIEF DESCRIPTION OF THE DRAWINGS

FIG. 1 is a front view of the multi-purpose ratchet pipe plier according to the present invention.

FIG. 2 is a top view of the multi-purpose ratchet pipe plier according to the present invention.

FIG. 3 is an A-A sectional view of the multi-purpose ratchet pipe plier according to the present invention.

FIG. 4 is a B-B sectional view of the multi-purpose ratchet pipe plier according to the present invention.

FIG. 5 is a C-C sectional view of the multi-purpose ratchet pipe plier according to the present invention.

### DESCRIPTION OF REFERENCE NUMBERS

1—handle; 11—assembly slot; 12—lower mortise; 2—upper jaw clamp; 21—upper mortise; 3—torsion spring; 31—limit pin;

4—arc- shaped tooth surface insert block; 41—arc-shaped tooth surface; 42—lower tenon; 5—upper tooth surface insert block; 51—upper tooth surface; 52—upper tenon; 6—pin shaft; 7—first fixing device; 8—second fixing device; 9—first tenon-disassembly screw; 10—second tenon-disassembly screw.

### DETAILED DESCRIPTION OF THE PRESENT INVENTION

The technical contents, structural features, objectives and effects of the present invention will be described in details by reference to the following description of embodiments of the present invention taken in conjunction with the accompanying drawings.

Referring to FIGS. 1-4, the present invention provides a piece of multi-purpose ratchet pipe plier, which comprises a handle 1, a pin shaft 6, an upper jaw clamp 2 and a torsion spring 3, wherein the upper jaw clamp 2 is hinged on the handle 1 through the pin shaft 6, the handle 1 is provided with an assembly slot 11, the torsion spring 3 is arranged in the assembly slot 11, one driving end of the torsion spring 3 is arranged on the upper jaw clamp 2, the other end of the torsion spring 3 is arranged on the assembly slot, the multi-purpose ratchet pipe plier further comprise an arc-shaped tooth surface insert block 4 and an upper tooth surface insert block 5, the arc-shaped tooth surface inset block 4 comprises an arc-shaped tooth surface 41 and a lower tenon 42, the head of the handle 1 is provided with a lower mortise 12 fit with the lower tenon 42, and the lower tenon 42 is fit with the lower mortise 12 to fix the arc-shaped tooth surface insert block 4 on the handle 1.

The upper tooth surface insert block 5 comprises an upper tooth surface 51 and an upper tenon 52, the upper jaw clamp 2 is provided with an upper mortise 21 fit with the upper tenon 52, and the upper mortise 21 is fit with the upper tenon 52 to fix the upper tooth surface insert block 5 on the upper jaw clamp 2.

Specifically, the assembly slot 11 is arranged on the handle 1 to receive the rear arm of the upper jaw clamp 2, the torsion spring 3 is arranged in the assembly slot 11, the upper jaw clamp 2 is hinged on the handle 1, the hinged position is arranged in the assembly slot 11 according to the embodiment of the present invention, and penetrates through the handle 1 and the shaft hole of the upper jaw clamp 2 through the pin shaft 6, the handle 1 and the pin shaft 6 are fixed, the upper jaw clamp 2 can rotate around the pin shaft 6, and in the embodiment, the upper jaw clamp 2 can rotate around the pin shaft 6 by over 90 degrees.

In normal use of the multi-purpose ratchet pipe plier in the new structure, the lower tenon 42 is inserted into the lower mortise 12, the upper tenon 52 is inserted into the upper mortise 21, then, the arc-shaped tooth surface 41 and the upper tooth surface 51 are matched to assemble and disassemble various workpieces, and after use for some time, when the anti-skip teeth are worn so as not to be used, the arc-shaped tooth surface insert block 4 and the upper tooth surface insert block 5 are drawn respectively from the lower mortise 42 and the upper mortise 21, and are replaced by new arc-shaped tooth surface insert block 4 and upper tooth surface insert block 5, greatly improving the service life of the multi-purpose ratchet pipe plier.

In the embodiment, referring to FIG. 3, the lower tenon 42 is arranged at the middle of the rear end of the arc-shaped tooth surface 41, the connection position of the lower tenon 42 and the arc-shaped tooth surface 41 is in stepped transition, the lower tenon 42 is fit with the lower mortise 12 in thickness, and in assembly, the stepped surface tightly presses on the top surface of the side wall of the lower mortise 12.

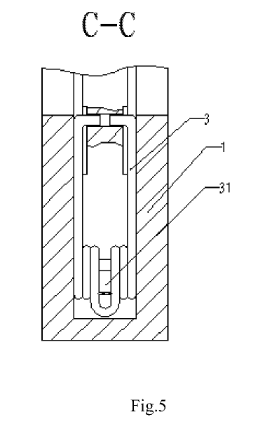

Referring to FIG. 4, the upper tenon 52 is arranged at the middle of the rear end of the upper tooth surface 51, the connection position of the upper tenon 52 and the upper tooth surface 51 are in stepped transition, the upper tenon 12 is fit with the upper mortise 21 in thickness, and in assembly, the stepped surface tightly presses on the top surface of the side wall of the upper mortise 21.

In the above two assembly modes, the upper mortise 21 the lower mortise 12 are straight long slots, the upper mortise 21 and the lower mortise 12 are rectangular in cross section, the slot walls have sufficient thickness so as to ensure the bending-resistance strength, further, after assembly, a certain gap is left between the upper tenon 52 and the upper mortise 21, namely, the stepped surface of the upper tooth surface tightly presses on the top surface of the wall of the upper mortise 21, a certain gap is also left between the lower tenon 42 and the bottom of the lower mortise 12, namely, the stepped surface of the arc-shaped tooth surface 41 tightly presses on the top surface of the wall of the lower mortise 12, thus, in use of the whole pipe plier, the stress on the arc-shaped tooth surface 41 and the upper tooth surface 51 is acted on the top of the mortise through the stepped surface, so that the whole pipe plier are more reasonable in stress.

In the embodiment, the upper tenon 52 and the upper mortise 21 as well as the lower tenon 42 and the lower mortise 12 are mutually fixed in interference fit manner for realizing the mutual tight fit, when needing to be disassembled and replaced, the upper tenon 52 and the lower tenon 42 are pulled out by a tool.

Certainly, they can be in transition fit which refers to clearance fit or interference fit.

When they are in interference fit, for firmly fixing the upper mortise 21 and the upper tenon 52 as well as the lower mortise 12 and the lower tenon 42, in the embodiment, the multi-purpose ratchet pipe plier comprise a first fixing device 7 and a second fixing device 8, after the lower tenon 42 is inserted into the lower mortise 12, the first fixing device 7 is used for fixing them, and after the upper tenon 52 is inserted into the upper mortise 21, the second fixing device 8 is used for fixing them.

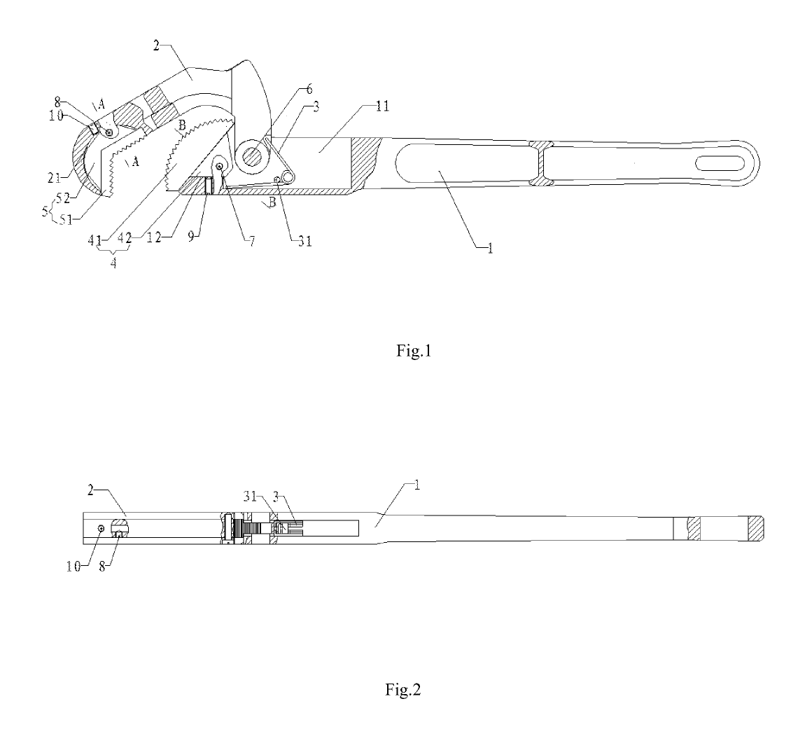

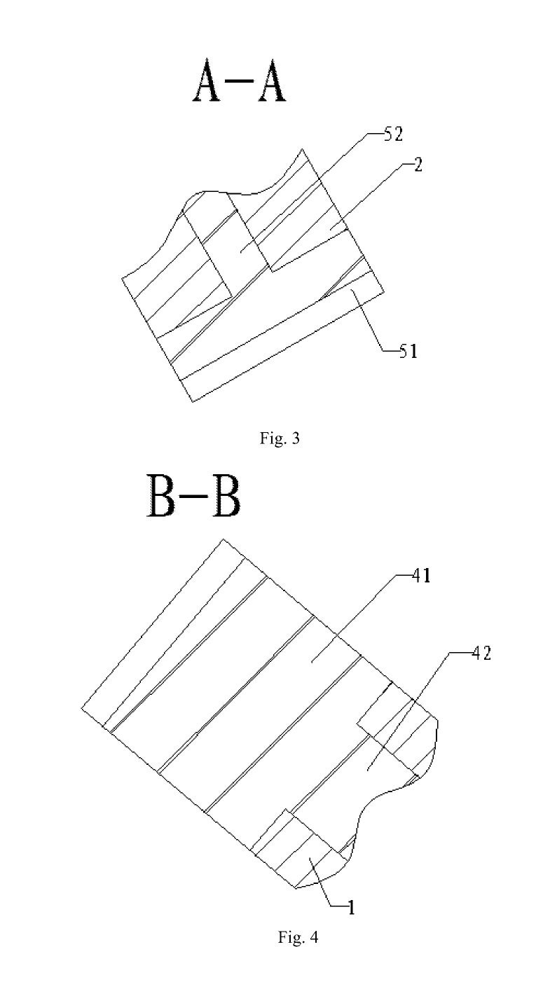

In an embodiment, referring to FIGS. 1 and 2, the first fixing device 7 is an anti-drop screw, one side wall of the lower mortise 12 is provided with a transparent hole, the other side wall of the lower mortise 12 is provided with a screw hole, the lower tenon 42 is provided with a through hole, and the anti-drop screw sequentially passes through the transparent hole and the through hole to be fit with the first screw hole to fix the lower tenon 42 on the handle 1.

After the anti-drop screw is fit and fixed with the first screw hole through a thread, the lower tenon 42 is firmly fixed in the lower mortise 12, namely, the arc-shaped tooth surface inset block 4 is firmly fixed on the handle 1, certainly, adopting the anti-drop screw is a technical scheme, the present invention does not restrict the specific form of the first fixing device 7, in other embodiments, the lower tenon 42 and the lower mortise 12 can be fixed by other ways, for example, the way of matching a bolt and a nut, namely, two side walls of the lower mortise 12 are provided with transparent holes respectively, the bolt sequentially passes through one transparent hole, the through hole and the other transparent hole to be fit with the nut to be fixed on the handle 1, and certainly, pins can also be adopted for fixing.

In the embodiment, referring to FIGS. 1 and 2, the second fixing device 8 is a fixing screw, one side wall of the upper mortise 21 is provided with a fixing screw hole, when the upper tenon 52 is inserted into the upper mortise 21, the fixing screw passes through the fixing screw hole to firmly hold the upper tenon 52 for realizing anti-drop function, certainly, when the second fixing device can also adopt the technical scheme of the above first fixing device, and the present invention does not make specific restriction on them.

In the embodiment, the upper tooth surface 51 is a V-shaped tooth surface, and the opening end of the V-shaped tooth surface faces to the handle 1.

Specifically, in the embodiment, the arc-shaped tooth surface 41 locates at the lower and faces the upper, the V-shaped tooth surface locates at the upper and faces the lower, the included angle of the vertical angle of the arc-shaped tooth surface is 120 degrees, thus, the V-shaped tooth surface actually comprises tooth surfaces at two different directions, which are opposite to the arc-shaped tooth surface from up to down, the three tooth surfaces form a plier opening for clamping the workpiece, and because three points can define a circle, the workpiece can be effectively clamped by adopting the way. The pipes which can not be clamped by the conventional wrench can be firmly clamped by the new wrench.

In the embodiment, the arc-shaped tooth surface 41 and the tooth form of the anti-skip teeth of the V-shaped tooth surface are inwards obliquely, and the angle of the tooth tip is less than 90 degrees, so as to realize the best anti-skip effect, the structure can be fit with other structures to tighten or loosen the threaded connector by outer force, namely, forward pressure is applied, the larger the outer force is, the more tightly the jaw can clamp the workpiece, when backward outer force is applied, the working position of the pipe plier is regulated, the jaw can be loosened, so that the pipe plier can easily reach new working position to realize the continuous working.

The lower mortise 12 can be directly communicated with the assembly slot 11, so that the handle 1 can be conveniently machined, and the structures of the lower tenon 12 and the lower mortise 12 are determined according to the specific shapes of the handle 1 and the upper jaw clamp 2.

In the embodiment, referring to FIGS. 1 and 2, the multi-purpose ratchet pipe plier also comprise a first tenon-disassembly screw 9 for pushing the lower tenon 42 out of the lower mortise 12, the handle 1 is provided with a second though hole communicated with the lower mortise 12, the first tenon-disassembly screw 9 is arranged into the second screw hole, and the tail end of the first tenon-disassembly screw 9 is propped against the lower tenon 42.

Similarly, the multi-purpose ratchet pipe plier also comprise a second tenon-disassembly screw 10 for pushing the upper tenon 52 out of the upper mortise 21, the upper jaw clamp 2 is provided with a third screw hole communicated with the upper mortise 21, the second tenon-disassembly screw 10 is arranged in the third screw hole, and the tail end of the second tenon-disassembly screw 10 is propped against on the upper mortise 52.

The upper tenon 52 and the lower tenon 42 can be conveniently disassembled by the two tenon-disassembly screws, specifically, by taking the first tenon-disassembly screw 9 as an example, when the lower tenon 42 is disassembled, the first tenon-disassembly screw 9 is screwed inwards, the first tenon-disassembly screw 9 pushes the lower tenon 42 out of the lower mortise 12, and the user can conveniently disassemble the arc-shaped tooth surface insert block 4.

In the embodiment, the multi-purpose ratchet pipe plier comprise a limit pin 31, the torsion spring 3 is a parallel-arranged double-torsion spring, and the limit pin 31 is arranged above the root of the lower arm of the parallel-arranged double-torsion spring.

Specifically, referring to FIGS. 1,2 and 5, the upper arm of the parallel-arranged double-torsion spring comprises double arms which are separated, the top ends of the double arms are respectively provided with bent feet the bending directions of which relatively face to the inner sides thereof, the bending angles are 90 degrees, the rear arm of the upper jaw clamp 2 is provided with a small through hole, the upper arm is inserted into the small through hole from the two sides of the rear arm of the upper jaw clamp 2, the two steel wires of the lower arm of the spring are connected together into a one piece of arm to be inserted below the pin shaft 6, the lower arm presses at the bottom of the assembly slot 11 of the handle 1, the limit pin 31 is arranged above the root of the lower arm to limit the lower arm of the spring to move by only clinging to the bottom surface of the assembly slot 11 of the handle 1, the upper jaw clamp 2 rotates to drive the upper arm and the lower arm of the parallel-arranged double-torsion spring to change in included angle, the spring tension always holds the upper jaw clamp 2 so as to enable it to reset, the parallel-arranged double-torsion spring is symmetric in structure so that the uncoordinated force mutually offsets, and only resultant force of the tension of the arms acts on the center line, so that the upper jaw clamp 2 smoothly resets.

The present invention does not specially restrict the arrangement mode of the parallel-arranged double-torsion spring, mainly, the upper jaw clamp 2 rotates to produce the change in the included angle between the upper arm and the lower arm of the parallel-arranged double-torsion spring, so as to produce reset force, thus, the parallel-arranged double-torsion spring can be arranged in various structures, for example, in an embodiment, the upper arm of the parallel-arranged double-torsion spring is arranged on the upper jaw clamp 2, and is consistent with the above structure, the lower arm of the parallel-arranged double-torsion spring is fixed on the handle 1, for example, the handle 1 is provided with a fixing hole, the bottom of the lower arm directly penetrates through the fixing hole to be fixed, or the end part of the lower arm is wound on the limit pin, in another scheme, the parallel-arranged double-torsion spring is arranged backwards, at this time, the upper arm is bent along the direction of the pin shaft, and is still arranged on the upper jaw clamp, the lower arm extends backwards the direction of the tail end of the handle, the limit pin is still above the root of the lower arm, the upper jaw clamp rotates to drive the upper arm to push the spring energy storage circle to move forwards, and the above structure can realize the change in included angle between the upper arm ad the lower arm so as to produce the reset elasticity.

The handle 1 is provided with a fixing shaft, and the lower arm is wound on the fixing shaft.

In the embodiment, the cross section of the front end of the upper jaw camp 2 is T-shaped, so that the whole upper jaw clamp 2 is light in weight, good in bending-resistance performance, the upper jaw clamp 2 rotates around the pin shaft 6 flexibly and smoothly, further, the back wall of the upper jaw clamp 2 is deigned into an arc shape so as to enable it to span the arc-shaped tooth surface, and is inserted into the assembly slot 11 from the rear part of the arc-shaped tooth surface, so that the arc-shaped tooth surface is complete, and further, when the multi-purpose ratchet pipe plier clamp the pipe with maximum diameter, namely, the plier opening is maximum, the clamp pipe can be clamped by the maximum tooth surface.

The above is only an embodiments of the present invention, therefore not limiting the scope of the present invention patent, any use of the present invention specification and the drawings by equivalent structural transformation or equivalent processes, either directly or indirectly use in other related technical fields, are similarly included in the present invention within the scope of patent protection.

1. A piece of multi-purpose ratchet pipe plier, which comprises a handle, an upper jaw clamp, a pin shaft and a torsion spring, wherein said handle is provided with an assembly slot, said upper jaw clamp is hinged on the assembly slot of the handle through the pin shaft, said torsion spring is arranged in the assembly slot, one driving end of the torsion spring is arranged on the upper jaw clamp, the other end of the torsion spring is arranged on the assembly slot, the multi-purpose ratchet pipe plier further comprise an arc-shaped tooth surface insert block and an upper tooth surface insert bock, said arc-shaped tooth surface insert block comprises an arc-shaped tooth surface and a lower tenon, the head of said handle is provided with a lower mortise fit with the lower tenon, and the lower tenon is fit with the lower mortise to fix the arc-shaped tooth surface insert block on the handle;
Said upper tooth surface insert block comprises an upper tooth surface and an upper tenon, said upper jaw clamp is provided with an upper mortise fit with the upper tenon, and the upper mortise is fit with the upper tenon to fix the upper tooth surface inset block on the upper jaw clamp.

2. A piece of multi-purpose ratchet pipe plier according to claim 1, is characterized in that, said lower tenon is arranged at the middle of the rear end of the arc-shaped tooth surface, the connection position of the lower tenon and the arc-shaped tooth surface is in stepped transition, the lower tenon is a straight tenon with rectangular cross section, the lower mortise is a straight long slot with rectangular cross section, when the lower tenon is inserted into the lower mortise, the stepped surface of the connection position of the arc-shaped tooth surface and the lower tenon tightly presses on the top surface of the wall of the lower mortise;
Said upper tenon is arranged at the middle of the rear end of the upper tooth surface, the connection position of the upper tenon and the upper tooth surface are in stepped transition, the upper tenon is a straight tenon with rectangular cross section, the upper mortise is a straight long slot with rectangular cross section, when the upper tenon is inserted into the upper mortise, the stepped surface of the connection position of the upper tooth surface and the upper tenon tightly presses on the top surface of the wall of the upper mortise.

3. A piece of multi-purpose ratchet pipe plier according to claim 2, is characterized in that, further comprise a first fixing device and a second fixing device, when the lower tenon is inserted into the lower mortise, the first fixing device is used for fixing them, and when the upper tenon is inserted into the upper mortise, and the second fixing device is used for fixing them.

4. A piece of multi-purpose ratchet pipe plier according to claim 3, is characterized in that, said first fixing device is an anti-drop screw, one side wall of said lower mortise is provided with a transparent hole, the other side wall of said lower mortise is provided with a first screw hole, said lower tenon is provided with a through hole, and said anti-drop screw sequentially passes through the transparent hole and the through hole to be fit with the first screw hole to fix the lower tenon on the handle.

5. A piece of multi-purpose ratchet pipe plier according to claim 3, is characterized in that, said second fixing device comprises a fixing screw, one side wall of the upper mortise is provided with a fixing screw hole, and the fixing screw passes through the fixing screw hole to tightly hold the upper tenon to fix the upper tenon on the upper jaw clamp.

6. A piece of multi-purpose ratchet pipe plier according to claim 1, is characterized in that, said tooth surface is a V-shaped tooth surface, and the opening end of the V-shaped tooth surface faces to the handle.

7. A piece of multi-purpose ratchet pipe plier according to claim 6, is characterized in that, the included angle between said arc-shaped tooth surface and the upper tooth surface is less than 90 degrees, and the tooth angle of said arc-shaped tooth surface and the tooth angle of the upper tooth surface are obliquely arranged.

8. A piece of multi-purpose ratchet pipe plier according to claim 1, is characterized by comprising a first tenon-disassembly screw for pushing the lower tenon out of the lower mortise, said handle is provided with a second screw hole communicated with the lower mortise, said first tenon-disassembly screw is arranged in the second screw hole, and the tail end of the first tenon-disassembly screw is propped against on the lower tenon.

9. A piece of multi-purpose ratchet pipe plier according to claim 1, is characterized by comprising an a second tenon-disassembly screw for pushing the upper tenon out of the upper mortise, said upper jaw clamp is provided with a third screw hole communicated with the upper mortise, said second tenon-disassembly screw is arranged in the third screw hole, and the tail end of the second tenon-disassembly screw is propped against on the upper tenon.

10. A piece of multi-purpose ratchet pipe plier according to claim 1, is characterized by comprising a limit pin, said torsion spring is a parallel-arranged double-torsion spring, said limit pin is arranged above the root of the lower arm of the parallel-arranged double-torsion springs to limit the lower arm of the spring to move by only clinging to the bottom of the assembly slot.
